(19) United States
(12) Patent Application Publication
(10) Pub. No.: US 2022/0048114 A1
(43) Pub. Date: Feb. 17, 2022

(54) METHOD FOR RELEASING METAL SUPPORT STRUCTURES IN AN ADDITIVE MANUFACTURING PROCESS

(71) Applicant: Bundesrepublik Deutschland, vertreten durch den Bundesminister für Wirtschaftund Energie, Berlin (DE)

(72) Inventors: Jens Günster, Clausthal-Zellerfeld (DE); Andrea Zocca, Berlin (DE)

(73) Assignee: Bundesrepublik Deutschland, vertreten durch den Bundesminister für Wirtschaftund Energie, Berlin (DE)

(21) Appl. No.: 17/275,818

(22) PCT Filed: Sep. 10, 2019
(86) PCT No.: PCT/EP2019/074095

§ 371 Date: Mar. 12, 2021

(30) Foreign Application Priority Data
Sep. 14, 2018 (DE) 10 2018 122 567.9

(51) Int. Cl. B22F 10/47; B22F 10/43; B22F 10/73; B22F 12/70

(52) U.S. Cl. CPC B22F 10/47; B22F 10/43; B33Y 10/00; B22F 12/70; B22F 10/73

(57) ABSTRACT

Method for additive manufacturing of a metallic component includes providing a metallic powder; providing and/or producing a metallic support structure on a build platform, wherein the metallic support structure has at least one detachment point having an electrical resistance different than an electrical resistance of an adjacent section of the support structure and an electrical resistance of an adjacent section of the metallic component; consolidating the metallic powder with formation of the metallic component and, optionally, with formation of the metallic support structure at least in sections, wherein the metallic support structure connects the metallic component to the build platform; releasing the metallic component from the metallic support structure by bringing about an electrical current in the detachment point.

### TECHNICAL FIELD

The invention is in the field of additive manufacturing or in the field of additive manufacturing methods and relates, in particular, to laser- and electron-beam-based methods based on metallic or metal-containing powders.

### PREVIOUSLY KNOWN PRIOR ART

Powder-based additive manufacturing is typically based on stacking individual powder layers and locally consolidating the powders to form the desired component. Metallic powders are consolidated locally in each case by means of 3D printing or selective melting using a laser or electron beam. In this case, particles of individual regions of the present layer are bonded among one another and to those of the underlying layer by means of a binder or are permanently fused by means of a laser or electron beam. A residual porosity can be reduced to close to 1% during melting. Selective melting using a laser or electron beam thus makes it possible to construct “ready to use” components which have a high density and can be used directly. However, the parts are initially still connected to the metallic build platform by a so-called support structure. The support structures fix the component in the powder bed, such that the component cannot be displaced during application of the powder layers and does not warp or deform during local melting of the powder. Moreover, the dissipation of heat from the component into the build platform takes place through the support structure. Support structures are thus indispensable. However, their construction and in particular the removal of the support structures constitute additional process steps that are time- and resource-intensive. They are an obstacle to autonomous manufacturing that can be realized by means of additive manufacturing, since the removal of the support structures is generally not automatable.

It is therefore an object of the present invention to provide a method which facilitates the removal of support structures and is automatable.

### BRIEF SUMMARY OF THE INVENTION

This object is achieved by means of a method as disclosed herein. Further embodiments, modifications and improvements are evident from the following description and the appended claims.

In particular, a method for additive manufacturing of a metallic component is proposed, the method comprising the following process steps:
providing a metallic powder;
providing and/or producing a metallic support structure on a build platform, wherein the metallic support structure comprises at least one detachment point having an electrical resistance that is different than an electrical resistance of an adjacent section of the support structure and than an electrical resistance of an adjacent section of the metallic component;
consolidating the metallic powder with formation of the metallic component and, optionally, with formation of the metallic support structure at least in sections, wherein the metallic support structure connects the metallic component to the work platform at or close to the detachment point;
releasing the metallic component from the metallic support structure,
wherein releasing the metallic component is effected by bringing about an electrical current in the detachment point, by virtue of the electrical current providing a thermal energy required for melting the detachment.

Furthermore, the use of this method for manufacturing a metallic component is proposed, wherein the metallic component is selected from: a denture or a constituent part thereof, a gearwheel, a turbine blade, or some other type of object.

### DETAILED DESCRIPTION

According to the invention, the heat required for the targeted melting of those sections of the support structure (detachment points) which are directly secured to the component is provided by electrical energy being converted into thermal energy. The expenditure in terms of time and costs required for removing support structures of additively manufactured metallic components is considerably reduced. In particular, the proportion of manual activities is reduced, such that the relevant manufacturing methods are fully automatable.

In accordance with one embodiment, a method for additive manufacturing of a metallic component is proposed. This method comprises the following process steps:
providing a metallic powder;
providing and/or producing a metallic support structure on a build platform,
wherein the metallic support structure comprises at least one detachment point having an electrical resistance that is different than an electrical resistance of an adjacent section of the support structure and than an electrical resistance of an adjacent section of the metallic component;
consolidating the metallic powder with formation of the metallic component and, optionally, with formation of the metallic support structure at least in sections,
wherein the metallic support structure connects the metallic component to the work platform at or close to the detachment point;
releasing the metallic component from the metallic support structure,
wherein releasing the metallic component is effected by bringing about an electrical current in the detachment point, by virtue of the electrical current providing a thermal energy required for melting the detachment point.

Advantages of this embodiment are afforded by the reduced outlay for completely freeing the metallic component.

In accordance with one embodiment, the proposed method furthermore comprises the following process step:
at least partly or completely recuperating powder from the metallic component and the support structure, wherein providing the metallic powder and consolidating are typically effected sequentially and layer by layer in a powder bed.

Advantages of this embodiment are afforded by the omission of the laborious removal—typically effected manually—of the support structures, which are often indispensable in the additive powder-bed-based manufacturing of metallic components, as a result of the component being released. A further advantage is afforded by the recovery/recycling of the metallic powder that is usable for forming new powder layers for the manufacturing of further new components before said powder is contaminated by additional, coarser particles that arise during melting of the detachment points.

In accordance with one embodiment, bringing about the electrical current in the detachment point is effected by contacting the work platform and the component with current-carrying terminals of a current source or by inducing an eddy current in the detachment point. The component, the support structure with the detachment points and the build platform typically form a closed conductor loop suitable for inducing a current flow by way of external alternating fields/

Advantages of this embodiment, in the case of direct contacting, e.g. with current terminals or pole shoes, are afforded by the reliable generation of a current flow upon the current source being switched on. In the case of inducing an eddy current in the detachment point(s), advantages are afforded by the contactless work steps, which do not require any special work steps, for contacting component and build platform.

In accordance with one embodiment, the detachment point has a reduced effective area cross section by comparison with an average cross section of the support structure.

In particular, the average area cross section of the support structure is significantly smaller at the detachment point than in a section further away from the metallic component by comparison with the detachment point. Advantages result from the support structure having at the detachment point a reduced current-carrying capacity for the same type of material. This results in increased heating by comparison with other sections of the support structure, possibly up to the level of the melting point of the material of the detachment point.

In accordance with one embodiment, the detachment point comprises an electrically conductive material having an increased electrical resistivity by comparison with the resistance of the remelted metal powder.

Advantages are afforded by a design of the detachment points that is less dependent on geometric relations. By way of example, a detachment point can be designed such that it is suitable for taking up higher mechanical loads (mechanical stresses).

In accordance with one embodiment, the detachment point comprises a material which comprises an electrically conductive material having a melting point that is lower than the melting point of the adjacent material of the support structure.

Advantages of this embodiment can result for example from the fact that after the melting of the material of the detachment point, the component is no longer (materially) connected to the support structure, but rests thereon, such that it can be removed from the support structure without damage to the component.

In accordance with one embodiment, the detachment point comprises a multiplicity of uniform cylinders that are adjacent to one another in groups, wherein an average cross-sectional area of an individual cylinder is from 0.0025 mm² to 0.1 mm².

Advantages of this embodiment comprise its simple representability by means of CAD software and a simple calculation of respective cross-sectional areas.

In accordance with one embodiment, a size of a contact area of the support structure with the component, that is to say the contact area of the detachment point with the component, is ½ to 1/20, preferably ⅕ to 1/20, more preferably ⅕ to 1/10, of the size of the contact area of the support structure with the build platform. In accordance with a modification of this embodiment, a cross-sectional area of the support structure, in particular the cross-sectional area of that section of the support structure which is referred to here throughout as detachment point, which cross-sectional area is situated in direct proximity to a surface of the component, can be ½ to 1/20, preferably ⅕ to 1/20, more preferably ⅕ to 1/10, of the size of the contact area of the support structure with the build platform.

What advantageously results from this is that the current-carrying capacity of the support structure is the lowest in contact with the component, that is to say at the detachment points, and the electrical resistance is thus the highest, such that during current-induced remelting the melting point of the support structure is reached the soonest at the detachment points.

In accordance with one embodiment, bringing about a current in the detachment point is effected by contacting the component and the work platform, wherein electrically contacting the component is effected by way of a liquid contact medium with an electrode arranged in the liquid contact medium.

Advantages are afforded by the substantially effortless contacting by means of dipping the component into the contact medium. Advantageously, the contact medium surrounds even complex geometries of a component, such that—depending on a possibly advantageous angle of inclination of the work platform with a component connected to the work platform via the support structure with respect to the surface of the liquid contact medium—all detachment points can be caused to melt simultaneously. By way of example, the electrode can be connected to a current source. Likewise, however, the electrode can also be an earth electrode. A potential difference present at least at times across the detachment point is crucial.

In accordance with one embodiment, the liquid contact medium is selected from: mercury, gallium, a gallium alloy, a metal bath, a salt melt, and an ionic liquid, wherein the component is dipped in the liquid contact medium as far as a plane that typically does not touch the support structure, such that in this way at locations where the component is wetted with the liquid contact medium the component is electrically contacted and for a current flow through the detachment point the build platform is connected to a current source via a further electrical contact.

Advantages of this embodiment are afforded by facilitated release of the metallic component from the support structure still connected to the build platform: the component simply falls into the liquid contact medium. Suitable support elements arranged in the container (e.g. trough, tank) containing the liquid contact medium make it possible to prevent the component from being wetted possibly undesirably with the liquid contact medium. A severe rise in a level of the liquid contact medium in the container during immersion and a possibly associated partial loss of the liquid contact medium or the contamination thereof can likewise be avoided.

In accordance with one embodiment, bringing about the electrical current is effected by means of a current pulse having an intensity of 300 to 3000 A for a pulse duration of 0.02 second to 1 second. By way of example, such a current pulse can be introduced into a suitably contacted component, such that it flows via the detachment points and, at least initially, brings about the at least partial melting thereof. A second current pulse and optionally further current pulses following it or a constant current flow can bring about the progressive melting of the residual detachment points.

A pulse having the duration referred to advantageously suppresses the formation of a plasma that might damage the surface of the metallic component, or suppresses an undesired spark erosion of the surface of the component.

In accordance with one embodiment, the proposed method further comprises:
forming a defined atmosphere enclosing the component, wherein the defined atmosphere comprises a reactive gas.

Advantageously, the presence of a reactive gas, at all the detachment points, brings about a rapid material removal, such that further melting (and material removal) is increasingly facilitated and accelerated.

In accordance with one embodiment, the reactive gas proposed above is selected from: air, oxygen, and an aerosol.

Advantageously, such an atmosphere allows facilitated removal of the material of the detachment point, for example by evaporation. In this regard, for example, a tungsten oxide formed in the presence of air or oxygen has a low vapor pressure, such that the formation thereof from a remelting tungsten detachment point brings about a rapid material removal that increasingly accelerates further melting and the material removal again associated therewith. Molybdenum oxide, too, is readily volatile. By means of an aerosol, it is also possible to offer alloying elements which then, at the superheated points of the detachment structure, lowers the melting point of the material from which component and support structure are constructed by way of alloying.

In accordance with an alternative embodiment, forming the defined atmosphere enclosing the component comprises forming an inert gas atmosphere.

Inert gases such as nitrogen or noble gases can advantageously prevent the formation of specific compounds, e.g. of oxides. With the use of powders comprising metal alloys, the formation of additional phases can be prevented in an inert gas atmosphere.

In accordance with one embodiment of the proposed method, bringing about the electrical current flow in the detachment point, or the detachment points, is preceded by recuperating powder from the component and the support structure. This is followed by embedding the support structure and at least the sections of the component which are connected to the support structure into a, preferably flowable, inert material.

Advantageously, the inert flowable material prevents the component from being contaminated with spatter of fusible metal. The flowable material arranged between build platform and component likewise prevents the formation of new (unwanted) contacted connections between component and support structure when the component subsides and rests on support structures that have already been detached previously. Heating-induced, at least partial, swelling of the inert flowable material or of one of its constituents brings about or considerably facilitates the release of the component from the support structure at the detachment points. The inert flowable material can comprise a quartz sand. The inert flowable material can likewise comprise a mineral or a mineral powder. By way of example, the inert flowable material can comprise vermiculite.

In accordance with a further embodiment, the use of a method in accordance with at least one of the embodiments mentioned above for manufacturing a metallic component is proposed. In this case, the metallic component is selected, for example, from a denture, a constituent part of a denture, a gearwheel, a turbine blade, or some other metallic component shaped in any desired way.

The method described can advantageously be used for the mass production of parts subject to wear, for example. Likewise, however, prototypes or small batch sizes of a metallic component can also easily be manufactured rapidly by means of 3D printing.

The embodiments described above can be combined with one another in any desired way. However, the invention is not restricted to the embodiments specifically described, but rather can be modified and altered in a suitable manner. It lies with the scope of the invention to suitably combine individual features and feature combinations of one embodiment with features and feature combinations of another embodiment in order to attain further embodiments according to the invention.

Overall, the proposed method considerably facilitates the separation of the component from the support structures connected to the build platform.

In accordance with customary technologies, for example selective laser melting (SLM), selective laser sintering (SLS) and electron beam melting of metallic powders, the components are attached to the metallic build platform by support structures. The support structures have to be removed from the component mechanically, which constitutes an additional and typically laborious process step. If the intention is to use support structures during laser deposition welding, too, then they should likewise be removed after the component has been manufactured. In accordance with the embodiments described above and explained further below, the metallic component and the metallic build platform, optionally after at least partial powder recuperation, are contacted such that at least one electrical current pulse, typically a sequence of a plurality of current pulses, flows through the metallic component and the support structures, and thus also flows through the detachment points of the support structures connecting the component to the support structures. By way of a locally increased ohmic resistance of geometrically predetermined sections of the support structures—and eddy currents additionally induced in the case of AC voltage, for example—and the drastic heating thus brought about, their current-induced melting and thus the release of the support structures from the component are brought about. Those sections of the support structure(s) which directly connect the component to the support structure are referred to above and below as detachment points. In this case, the term detachment point denotes a three-dimensional section of the support structure which is in direct proximity to the surface of the metallic component.

By way of example, the metallic support structures are constructed such that in sections they are more filigree than the metallic component and thus offer a smaller cross section for the current flow, thus resulting locally in heating of the sections of the support structure specifically provided therefor, that is to say of the detachment points, up to the melting point of the metals or alloys forming the detachment points. Through targeted design of the support structures, in particular of the detachment points of the support structure, which are in direct contact with the metallic component, for example their cross section is reduced in a targeted manner by comparison with an average effective cross section of component and support structures. The sections having a reduced cross section and thus a significantly reduced current-carrying capacity define the geometry of the detachment zone. By bringing about an electrical current in the detachment point, for example by means of an electrical voltage between the metallic build platform and the metallic component, it is possible to generate such a current flow which at the detachment points, which can be e.g. points having the smallest cross section of the support structure, as a result of heating by means of ohmic resistance these are heated in such a way that locally they melt and release the component or at least make it mechanically removable from the support structure with comparatively little expenditure in terms of work and force.

For this basic embodiment it can be assumed that the support structure offers for a current flow a maximum of approximately ½ of the cross-sectional area than the actual component or the build platform. This results in an increased electrical resistance, Rₛᵤₚₚₒᵣₜ, of the support structure relative to the component. After the additive construction of the metallic component, said electrical resistance is connected in series with the electrical resistances of component and build platform when a voltage is applied between component and build platform. A simple consideration of the current flow of resistances connected in series yields the following for the power converted at the component, the support structure and the build platform in the case of a current flow I and a given voltage U:

P=U·I power

U=R·I voltage dropped across the resistance R

P=R·I² power converted at the resistance R

R is proportional to the cross-sectional area A
where A_{detachment}=½ A_{component} resulting in: R_{detachment}=2 R_{component}

The power available at the detachment point for heating the detachment point is at least double the magnitude of that in the component or the build platform or the support structure. In accordance with typical embodiments, for rapid heating the powers should be at least in the kW range per mm² of A_{detachment}. The length of a detachment point is typically from 0.1 mm up to a few 10 mm.

This therefore yields the following table for 1 kW heating power, 1 mm² cross-sectional area of the support structure and 10 mm length of the detachment point for some metals, selected merely by way of example.

| | | | Specific | | Cross- | | |
|---|---|---|---|---|---|---|---|
| | Electrical | Melting | heat | | sectional | Current | Pulse |
| | resistivity | point | capacity | Density | area Aₛᵤₚₚₒᵣₜ | intensity | duration |
| Metal | Ω · mm²/m | ° C. | J/(g · K) | g/cm³ | mm² | A | s |
| Aluminum | 0.028 | 660 | 0.89 | 2.7 | 1 | 1870 | 0.015 |
| High-grade | 0.72 | 1500 | 0.45 | 7.9 | 1 | 373 | 0.052 |
| steel | | | | | | | |
| Titanium | 0.8 | 1800 | 0.52 | 4.5 | 1 | 353 | 0.041 |
| Copper | 0.017 | 1083 | 0.38 | 8.9 | 1 | 2425 | 0.036 |

The duration—required for the melting of the detachment points—of a current pulse of corresponding current intensity flowing via the support structure (detachment point) results from the heating of a material volume of 1 mm² cross-sectional area and 10 mm height to melting points with 1 kW heating power, without taking account of heat losses occurring as a result of radiation or convection. In addition, by means of a transient thermal treatment (cooling or heating) of the support structure, it is possible to set the electrical resistance of the detachment point relative to that of the component or of the support structure, which generally has a smaller surface area relative to the volume and cools down or heats up less rapidly as a result. As is known, in the case of metallic materials, an increase in temperature generally leads to an increase in the ohmic resistance. Local heating by way of ohmic resistance thus leads to the formation of “hot spots”, since the heating in turn increases the resistance. Consequently, only relatively small changes in the cross-sectional area of the detachment structure are necessary in order to exploit this self-reinforcing effect.

In accordance with one typical embodiment, it is proposed to cause an electrical current to flow between the component and the work platform. As a result of the electrical resistance at one or more sections of the metallic support element (of the detachment point(s)) with a reduced current-carrying capacity, the support element is heated at exactly these sections (detachment points) up to the temperature required for melting. Consequently, electrical current is locally converted into the heat required for melting.

The electrical heating current firstly softens that part of the metallic support element with the lowest current-carrying capacity and then brings about the melting thereof, as a result of which the current flow is locally interrupted on account of the effect of the surface tension of the melted metal according to the principle of a blowing fuse (fusible link). Remaining current-carrying sections of low current-carrying capacity, which have already been heated anyway, are heated to an even greater extent on account of the current intensity increasing in a cascade-like manner and are likewise interrupted by melting.

To put it another way, the use of electrically conductive support structures comprising one or more detachment points with reduced current-carrying capacity as a locally meltable support element for the additive manufacturing of metallic components is proposed. In this case, the reduced current-carrying capacity can be achieved by means of a local reduction of the effective cross section in the relevant section of the support structure. Alternatively, the reduced current-carrying capacity can be brought about by way of a different specific electrical conductivity, e.g. on account of a different type of material.

The support elements are thus suitably adapted for the desired melting characteristic and are embodied in the form of detachment points in a region that is directly in contact with the metallic component. The cross-sectional area of detachment points can be reduced by comparison with an average cross-sectional area of the support structure. The cross section of the support structure in the region of its direct contact with the metallic component is typically reduced to ½ to 1/10, in particular between ½ and ⅕, of the average cross-sectional area of the support structure.

Support structures suitable for the purpose described are designed in such a way that they have a reduction of their cross section for the current flow between component and build platform. At the point of reduced cross section, melting of the support structure is then initiated by the current flow. At the moment of local melting of the support structure, the component is separated by lift-off/release from the build platform. The ohmic resistance of the support structure can be additionally increased by the support structure being heated by means of air flow that heats the support structure more rapidly on account of the increased surface area of the filigree support structure relative to the component.

The contacting of the component and the build platform that is required for this is effected by way of a device suitable for this, for example suitably dimensioned cables. It is likewise possible for the component to be released from the support structure under the component's own weight. For example, by way of a liquid or flexible contact medium, e.g. a mercury bath, the component can be contacted with an electrode contacting the mercury bath, wherein the electrode is connected to a current source, while the build platform arranged thereabove (upside down) is reliably connected to the current source by a suitably dimensioned cable, e.g. via a pole shoe.

In accordance with another embodiment, an eddy current induced in the detachment point(s) of the support structure(s) can generate the heat required for releasing the detachment point(s) as intended. By way of example, an eddy current can be induced by means of a coil driven with AC current. A magnetron can likewise be used to induce the necessary eddy currents by means of high-frequency microwave radiation and thus to provide the required melting energy. The support structure can have a geometry which specifically enables an eddy current or current to be induced by an external alternating field.

The invention thus proposes ultimately using electrical current for locally melting support structures and detaching metallic components from the build platform comprising the support structures in additive manufacturing.

Removing support structures by means of specifically adapting their ohmic resistance in conjunction with melting the support structures by means of a current surge makes it possible to considerably facilitate the separation of the component from the support structure. Even very complex geometries can be separated easily and rapidly using this technology and automation of this process is easily possible even for varying component geometries.

Aspects of the proposed method thus relate to:

1. Removing loose powder or recuperating powder from the component and the support structures.

2. Applying an electrical voltage between component and build platform, generating a current flow through the support structure and thereby locally selectively melting the support structure and separating the component.

3. Constructing a metallic support structure taking account of its electrical, ohmic resistance by adapting the cross section of the support structure that is available for a current flow between component and build platform.

4. Process steps of the process for detaching a metallic component thus comprise: applying an electrical voltage between component and build platform, generating a current flow through the support structure and the detachment points thereof that are directly electrically connected to the component, locally heating the detachment points by way of their ohmic resistance set specifically over the length of the support structure, locally melting the support structure at locations of their electrical contact with the component (i.e. melting the detachment points), and separating or removing the component.

5. Heating the component with support structures by means of a heat flow, e.g. hot air, as a result faster heating of the detachment points of the support structure by virtue of a design of the support structure that is suitable for this, e.g. by way of a large surface area in relation to the volume in the region of the detachment points, and thus locally (selective) increase in the ohmic resistance of the metallic support structure in the region of the detachment points.

6. Setting a defined atmosphere, for example an oxidizing atmosphere, which fosters the formation of readily volatile metal oxides and the evaporation thereof with the melting (example: tungsten, molybdenum).

Even though specific embodiments have been presented and described herein, it lies within the scope of the present invention to suitably modify the embodiments shown, without departing from the scope of protection of the present invention. The following claims constitute a first, non-binding attempt to generally define the invention.

1. Method for additive manufacturing of a metallic component, comprising:
providing a metallic powder;
providing and/or producing a metallic support structure on a build platform,
wherein the metallic support structure comprises at least one detachment point having an electrical resistance that is different than an electrical resistance of an adjacent section of the support structure and than an electrical resistance of an adjacent section of the metallic component;
consolidating the metallic powder with formation of the metallic component,
wherein the metallic support structure connects the metallic component to the build platform;
releasing the metallic component from the metallic support structure,
wherein releasing the metallic component is effected by bringing about an electrical current in the detachment point, by virtue of the electrical current providing a thermal energy required for melting the detachment point.

2. Method according to claim 1, further comprising:
at least partly recuperating powder from the metallic component and the support structure,
wherein providing the metallic powder and consolidating are effected layer by layer.

3. Method according to claim 1, wherein bringing about the electrical current in the detachment point is effected by contacting the work platform and the component or by inducing an eddy current in the detachment point.

4. Method according to claim 1, wherein the detachment point has a reduced effective area cross section by comparison with an average cross section of the support structure.

5. Method according to claim 1, wherein the detachment point comprises an electrically conductive material having an increased electrical resistivity by comparison with the resistance of the remelted metal powder.

6. Method according to claim 1, wherein the detachment point comprises an electrically conductive material having a lower melting point than the adjacent material of the support structure.

7. Method according to claim 1, wherein the detachment point comprises a multiplicity of uniform cylinders that are adjacent to one another in groups, and an average cross-sectional area of an individual cylinder is from 0.0025 mm² to 0.1 mm².

8. Method according to claim 1, wherein a size of a contact area of the support structure with the component is ½ to 1/20 of the size of the contact area of the support structure with the build platform.

9. Method according to claim 3, wherein contacting the component and the work platform is effected, and contacting the component is effected by way of a liquid contact medium with an electrode arranged in the liquid contact medium.

10. Method according to claim 9, wherein the liquid contact medium is selected from: mercury, gallium, a gallium alloy, a metal bath, a salt melt, and an ionic liquid, wherein the component is dipped in the liquid contact medium as far as a plane that typically does not touch the support structure, and for a current flow through the detachment point the build platform is connected to a current source via a further electrical contact.

11. Method according to claim 1, wherein bringing about the electrical current is effected by introducing a current pulse having an intensity of 300 to 3000 A for a pulse duration of 0.02 second to 1 second.

12. Method according to claim 1, further comprising:
forming a defined atmosphere enclosing the component, wherein the defined atmosphere comprises a reactive gas.

13. Method according to claim 12, wherein the reactive gas is selected from: air, oxygen, and an aerosol.

14. Method according to claim 1, further comprising:
forming a defined atmosphere enclosing the component, wherein the defined atmosphere comprises an inert gas.

15. Method according to claim 2, further comprising:
embedding the support structure and at least one section of the component which is connected to the support structure into an inert material, wherein the embedding is effected before bringing about the electrical current in the detachment point.

16. Method according to claim 1, wherein the metallic component is selected from the group consisting of a denture or a constituent part thereof, a gearwheel, and a turbine blade.

17. Method according to claim 1, wherein the consolidating step also forms the metallic support structure at least in sections.

18. Method according to claim 8, wherein the size of the contact area of the support structure with the component is ⅕ to 1/20 of the support structure with the build platform.

19. Method according to claim 8, wherein the size of the contact area of the support structure with the component is between ⅕ and 1/10 of the support structure with the build platform.
